(19) United States
(12) Patent Application Publication
(10) Pub. No.: US 2020/0259779 A1
(43) Pub. Date: Aug. 13, 2020

(54) SUPER CHAT

(71) Applicant: GLOBAL ELMEAST INC., Sunnyvale, CA (US)

(72) Inventors: Zaide Liu, Beijing (CN); Christopher L. Wong, Palo Alto, CA (US); Nathon Wong, San Jose, CA (US); Kam Miller, Capitola, CA (US); Lawrence McFadden, Oakland, CA (US)

(21) Appl. No.: 16/274,017

(22) Filed: Feb. 12, 2019

(51) Int. Cl. H04L 12/58

(52) U.S. Cl. CPC H04L 51/36; H04L 51/16; H04L 51/12; H04L 51/10

(57) ABSTRACT

Approaches, techniques, and mechanisms are disclosed for online chat communications between and among various disparate online chat communication systems. A super chat group comprising chat participants from online chat communication systems is created. An incoming online chat communication from an origination chat application operated by an origination chat participant in the super chat group is received from an origination online chat communication system in the online chat communication systems. Destination chat participants in the super chat group are identified based on destination chat participant information received with the incoming online chat communication. Outgoing online chat communications to destination online chat communication systems to which destination chat applications operated by the destination chat participants correspond are transmitted.

### TECHNICAL FIELD

Embodiments relate generally to realtime or near realtime online communication systems, and, more specifically, to facilitating intercommunications among disparate realtime or near realtime communication systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Many online chat applications, such as Slack, Line, WhatsApp, WeChat, Skype, etc., are available for users across different parts of the world to select and to conduct highly interactive and instantaneous online chat communications among one another over the internet. While users may or may not be restricted to only using any given online chat application, most users, on account of their communication habits and/or their social and online environments, are likely to settle into using a specific online chat application to communicate with other users of the same online chat application.

As a result, the entire online chat user population is fractured into different isolated or insulated online chat user segments corresponding to different online chat applications, and each online chat user segment uses a respective online chat application. Users in a first user segment corresponding to a first online chat application may communicate with other users of the same online chat application but not with users in different user segments corresponding to other online chat applications.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A and FIG. 1B are illustrative views of various aspects of an example system;

FIG. 2 is an illustrative view of various aspects of an example (e.g., cloud-based, etc.) chat bridging system;

FIG. 3A through FIG. 3D and FIG. 4 illustrate example flows; and

FIG. 5 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

1.0. General Overview

2.0. Structural Overview
2.1. Chat Communication Systems
2.2. Bridging Between Disparate Chat Systems
2.3. Auto Natural Language Translation And Service Adaptation
2.4. User Registration and Super Chat Group Creation
2.5. Chat Exchange, Auto Translation and Service Adaptation
2.6. Chat Related Services
2.7. Chat Data Services
2.8. Tearing Down Super Chat Groups
2.9. Presence and Intention

3.0. Example Embodiments

4.0. Implementation Mechanism—Hardware Overview

5.0. Extensions and Alternatives

### 1.0. General Overview

A user may choose to work with a favorite (or personally accustomed) chat app because of the user's own communication habits and social/network environment. It may be very difficult even impossible for the user to switch between different chat application.

An enterprise collaboration project may involve different team groups/members scattering across different countries. These team groups/members working on the same project may use different chat applications such as Slack, Line, WhatsApp, WeChat, Skype, etc. that are not capable of communicating with one another.

Techniques as described herein can be implemented to provide (e.g., cloud-based, etc.) super chat services that allow anyone in the world to continue using a favorite chat app to exchange chat communications with anyone else in the world without any country boundary and/or chat application/system boundary. Under these techniques, a chat user who uses a first chat app among a plurality of different chat apps is enabled by way of a chat bridging system to communicate with another user who may use a second different chat app among the plurality of different chat apps.

Collaborative teams composed of groups/members in multi-national (and/or global) enterprises/organizations can use super chat techniques as described herein to allow or enable these groups/members to collaborate among themselves without forcing anyone to switch to different chat apps or alter communication habits.

Super chat techniques can be also used for individuals to form chat groups across different countries without firewall and chat app barriers. A virtual chat group (e.g., a super chat group, etc.) can be created on the fly while users of the virtual chat group can continue using their respective chat apps.

Example approaches, techniques, and mechanisms are disclosed for online chat communications among multiple (e.g., incompatible, isolated, individual, etc.) online chat communication systems. According to one embodiment, a super chat group comprising a plurality of chat participants from a plurality of online chat communication systems is created. Each chat participant in the plurality of chat participants uses a respective chat application in a plurality of chat applications. Each chat application in the plurality of chat applications corresponds to a respective online chat communication system in the plurality of online chat communication systems. An incoming online chat communication from an origination chat application operated by an origination chat participant in the plurality of chat participants in the super chat group is received from an origination online chat communication system in the plurality of online chat communication systems. One or more destination chat participants in the plurality of chat participants in the super chat group are identified based at least in part on destination chat participant information received with the incoming online chat communication. One or more outgoing online chat communications are transmitted to one or more destination online chat communication systems to which one or more destination chat applications operated by the one or more destination chat participants correspond. Each of the one or more outgoing online chat communication is generated from the incoming online chat communication.

In other aspects, the invention encompasses computer apparatuses and computer-readable media configured to carry out the foregoing techniques.

### 2.0. Structural Overview

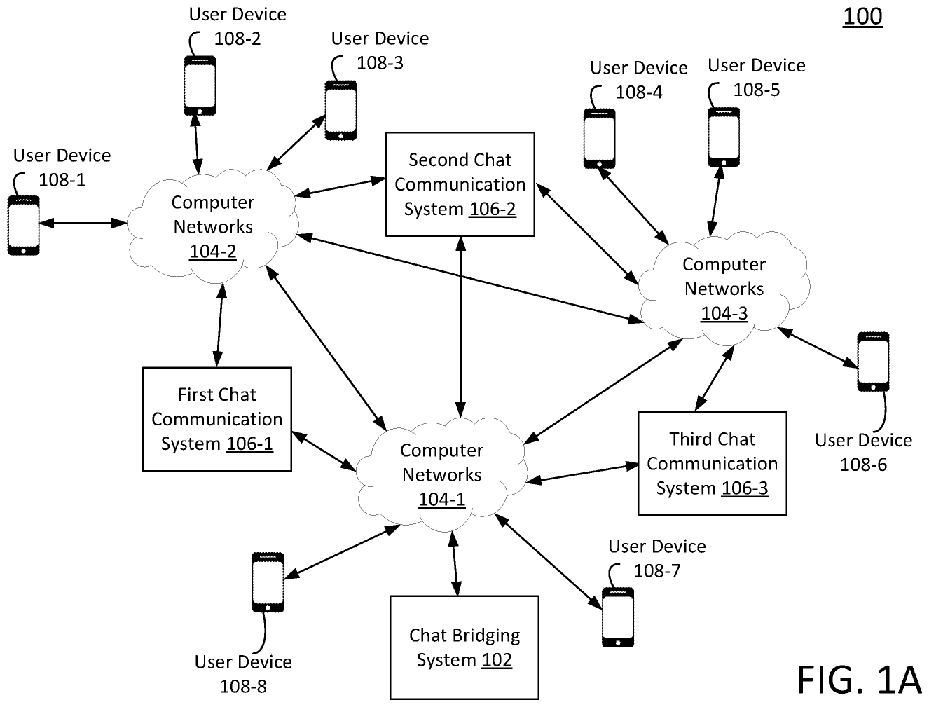

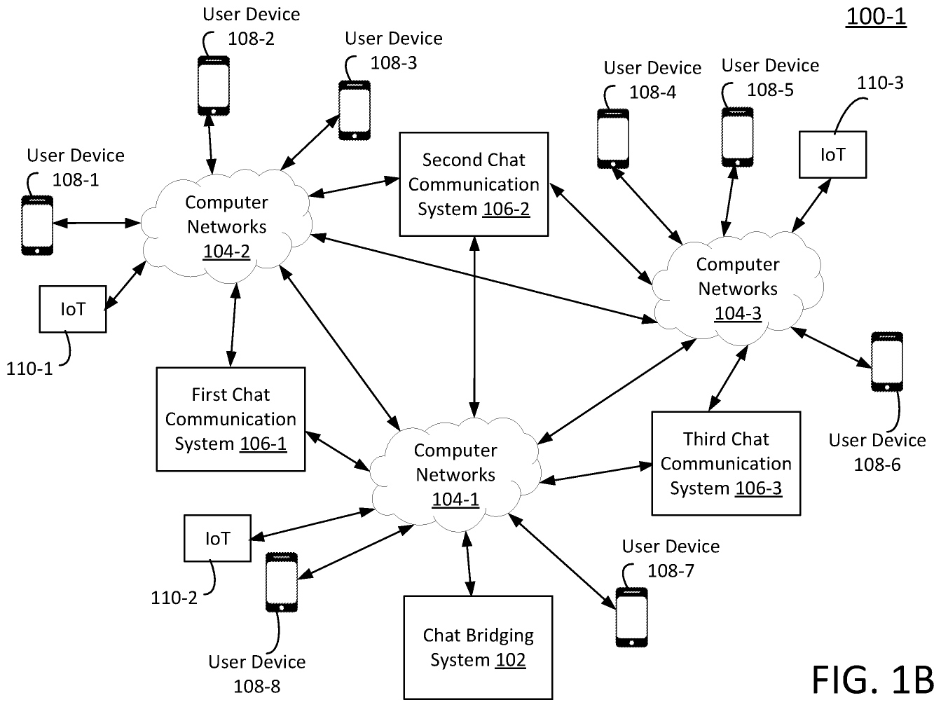

FIG. 1A is an illustrative view of various aspects of an example system 100 in which the techniques described herein may be practiced, according to an embodiment. System 100 comprises one or more computing devices. The one or more computing devices comprise any combination of hardware and software configured to implement the various logical components described herein, including components such as chat bridging system 102, first chat communication system 106-1, second chat communication system 106-2, third chat communication system 106-3, user devices 108-1 through 108-8, and so forth. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

2.1. Chat Communication Systems

System 100 comprises two or more disparate online chat communication systems 106-1 through 106-3 each of which allows user devices of (e.g., a user registered to, running an online chat application or app corresponding or acting as corresponding client application to, etc.) the same chat communication system to communicate with one another (e.g., in a chat group created with the chat communication system, etc.) over one or more computer networks 104-1 through 104-3. By way of illustration but not limitation, the first online chat communication system 106-1 may represent a Slack (online chat communication) system/service; the second online chat communication system 106-2 may represent a Line (online chat communication) system/service; the third online chat communication system 106-3 may represent a WeChat (online chat communication) system/service.

Example computer networks as described herein include, but are not necessarily limited to, wired networks, wireless networks, optical networks, local area networks (LANs), wide area networks (WANs), core networks, virtual private networks (VPNs), carrier networks, intranets, the internet, public networks, private or proprietary networks, satellite networks, dedicated network links/paths, service provider networks, cellular networks, radio networks, access networks, edge networks, inter-regional networks, international networks, and so forth. Further, communications and exchanges of data, text, voice, multimedia, etc., over some or all of the computer networks 104-1 through 104-3 may utilize a variety of networking protocols, including but not necessarily limited to only TCP/IP based networking protocols, HTTP protocols, JSON protocols, XML protocols, REST protocols, and so forth.

Example user devices as described herein include, but are not necessarily limited to only, mobile phones, end-user computing devices, desktop computers, laptop computers, tablet computers, smart phones, wearable computing devices, headmounted computing devices, smart watches, and so forth.

Online chat communications as described herein may refer to any kind of communication (e.g., in a chat group created with a given chat communication system, etc.) over computer networks such as the Internet that provides or supports basic (e.g., free, etc.) and/or enhanced (e.g., fee-based, etc.) online chat-related services. Example online chat-related services may include, but are not necessarily limited to only, any of: real-time transmissions/exchanges of (e.g., short, etc.) text messages between two user devices or among multiple user devices, real-time voice services/chats between two user devices, real-time voice teleconference services/chats among multiple user devices, real-time voice multicasting or broadcasting services from one or more user devices to other user devices, real-time video services/chats between two user devices, real-time video teleconference services/chats among multiple user devices, real-time video multicasting or broadcasting services from one or more user devices to other user devices, etc. As used herein, the term “real time” (e.g., text, voice, video, etc.) communication may include instantaneous communications, highly interactive communications, near real time communications, including but not limited to real time communications subject to only network propagation delays.

Online chat communications are different from email communications, internet-based newsgroups, internet-based forums, etc., which also may be carried over the internet.

For example, email communications of all email users—who are typically allowed to communicate with one another not limited to be within a single email domain or a single email system—rely on (e.g., public, standard, etc.) common email protocols, not on any specific email applications that are used by the email users to exchange emails. Any email applications that support the common email protocols can be used to effectuate email communications between any email user and any other email users through systems owned and/or operated by different entities. Email communications may be relayed through zero or more intermediate (internal and/or external) email servers that implement the common email protocols. Any email servers involved in exchanging emails may set or implement their own email queuing, dequeuing and transferring schedules to relay emails on a delayed, non-real-time basis without violating the supported common email protocols. An email user who sends an email to another email user by way of an origination email server, relay email server(s) and a destination email server does not have to complete any registration procedure with (most if not all) these email servers in order to receive (e.g., origination, relaying, destination, etc.) email services from these email servers. Thus, emails including but not limited to spams may be sent from an email sender to an email recipient by way of an email server even though the email sender is completely unknown to the email server. In addition, available email services are typically specified based on the email standards/protocols, which are the same for all email users and/or email servers.

In contrast, online chat communications by a specific (online chat) user rely on a specific online chat app used by the user. A specific online chat communication system to which the specific online chat communication app corresponds typically allows the user (or user device) only to communicate with other users (e.g., contacts of the user, in a chat group created with a given chat communication system, etc.) running the same specific online chat communication app—subject to version differences that may exist among different users of the same online chat communication system—that corresponds to the same specific online chat communication system. The specific online chat communication system relays some or all of online chat communications in real time or in near real time (e.g., within a fraction of second, within two seconds, etc.). The specific user who intends to exchange online chat communications with the other users by way of the specific online chat communication system first completes a registration procedure with the specific online chat communication system. Online chat communications (e.g., a conversation, etc.) may be exchanged between two online chat users by way of an online chat communication system, provided that both online chat users are known by (e.g., registered with, etc.) the online chat communication system operated and/or owned by a single entity; in many circumstances, both online chat users have to know each other, for example through the users' contact lists, a chat group, etc. In addition, available online chat services are typically differentially provided/supported (e.g., one system may support text only chats whereas another system may support voice chats, video chats, rich-content-based chats, etc.) among different online chat communication systems.

On account of respective communication habits and/or social and online environments, different users operating different user devices such as 108-1 through 108-8 may select, download and/or run different online chat applications corresponding, or acting as respective corresponding client applications, to different online chat systems.

For example, first user devices 108-1, 108-2 and 108-7 as illustrated in FIG. 1A or first users operating these devices may elect to run a first online chat app corresponding, or acting as a corresponding client application, to the first online chat communication system 106-1 with which the first user devices 108-1, 108-2 and 108-7 communicate (e.g., send outgoing chat communications, receive incoming chat communications, etc.) over the computer networks 104-1 and 104-2. Second user devices 108-3 and 108-4 may elect to run a second online chat app corresponding, or acting as a corresponding client application, to the second online chat communication system 106-2 with which the second user devices 108-3 and 108-4 communicate (e.g., send outgoing chat communications, receive incoming chat communications, etc.) over the computer networks 104-2 and 104-3. User devices 108-5 and 108-6 may elect to run a third online chat app corresponding, or acting as a corresponding client application, to the third online chat communication system 106-3 with which the third user devices 108-5 and 108-6 communicate (e.g., send outgoing chat communications, receive incoming chat communications, etc.) over the computer networks 104-3.

Each of the first users operating the first user devices 108-1, 108-2 and 108-7 may complete a first registration procedure with the first online chat communication system 106-1. Each of the second users operating the second user devices 108-3 and 108-4 may complete a second registration procedure with the first online chat communication system 106-2. Each of the third users operating the third user devices 108-5 and 108-6 may complete a third registration procedure with the third online chat communication system 106-3.

A first chat group may be set up or created (e.g., on the fly, as needed, etc.) in the first online chat communication system 106-1 by one of the first users registered with the first online chat communication system 106-1. Any, some or all of the first users registered with the first online chat communication system 106-1 such as those operating the first user devices 108-1, 108-2 and 108-7 running the first online chat app corresponding, or acting as a corresponding client application, to the first online chat communication system 106-1 may join the first chat group as chat group members. The first users operating the first user devices 108-1, 108-2 and 108-7 may use the first online chat app running on the first user devices 108-1, 108-2 and 108-7 to exchange online chat communications (e.g., in the first group, in another chat group in the first online chat communication system 106-1 so long as the first users are chat group members of that group, etc.) with one another by way of the first online chat communication system 106-1.

A second chat group may be set up or created in the second online chat communication system 106-2 by one of the second users registered with the second online chat communication system 106-2. Any, some or all of the second users registered with the second online chat communication system 106-2 such as those operating the second user devices 108-3 and 108-4 running the second online chat app corresponding, or acting as a corresponding client application, to the second online chat communication system 106-2 may join the second chat group as chat group members. The second users operating the second user devices 108-3 and 108-4 may use the second online chat app running on the second user devices 108-3 and 108-4 to exchange online chat communications (e.g., in the second group, in another chat group in the second online chat communication system 106-2 so long as the second users are chat group members of that group, etc.) with one another by way of the second online chat communication system 106-2.

A third chat group may be set up or created in the third online chat communication system 106-3 by one of the third users registered with the third online chat communication system 106-3. Any, some or all of the third users registered with the third online chat communication system 106-3 such as those operating the third user devices 108-5 and 108-6 running the third online chat app corresponding, or acting as a corresponding client application, to the third online chat communication system 106-3 may join the third chat group as chat group members. The third users operating the third user devices 108-5 and 108-6 may use the third online chat app running on the third user devices 108-5 and 108-6 to exchange online chat communications (e.g., in the third group, in another chat group in the third online chat communication system 106-3 so long as the third users are chat group members of that group, etc.) with one another by way of the third online chat communication system 106-2.

Since online chat communications are facilitated through a specific online chat communication system among the first, second and third online chat communication systems 106-1 through 106-3 and are thus dependent on the specific online chat communication system, the first users operating with the first online chat app may be limited or insulated to exchange online chat communications among themselves (e.g., in contacts list set up with the specific online chat communication system, in a chat group set up with the specific online chat communication system, etc.), but not with other users of other online chat communication systems.

For example, a first user operating a first user device (e.g., 108-1, etc.) may be enabled and/or facilitated by the first online chat communication system 106-1 to exchange (e.g., send and/or receive, etc.) online chat communications with a second user operating a second user device (e.g., 108-2, etc.), a seventh user operating a seventh user device (e.g., 108-7, etc.), etc., by way of the first online chat communication system 106-1, if the second user, the seventh user, etc., can be found in the first user's contacts list set up with the first online chat communication system 106-1, if the first user, the second user, the seventh user, etc., can be found in a chat group (such as the first chat group) set up with the first online chat communication system 106-1.

Any of the first users such as the first user operating the first user device 108-1, the second user operating the second user device 108-2, the seventh user operating the seventh user device 108-7, etc., may not be enabled and/or facilitated by the first online chat communication system 106-1 to exchange (e.g., send and/or receive, etc.) online chat communications with the third user operating the third user device 108-3, the fourth user operating the fourth user device 108-4, the fifth user operating the fifth user device 108-5, the sixth user operating the sixth user device 108-6, etc., as the third user, the fourth user, the fifth user, the sixth user, etc., are not in (e.g., not registered with, cannot be found in contacts lists or chat groups set up with the first online communication system 106-1, etc.) with the first online chat communication system 106-1.

Any of the second users such as the third user operating the third user device 108-3, the fourth user operating the fourth user device 108-4, etc., may not be enabled and/or facilitated by the second online chat communication system 106-2 to exchange (e.g., send and/or receive, etc.) online chat communications with the first user operating the first user device 108-1, the second user operating the second user device 108-2, the fifth user operating the fifth user device 108-5, the sixth user operating the sixth user device 108-6, the seventh user operating the seventh user device 108-7, etc., as the first user, the second user, the fifth user, the sixth user, the seventh user, etc., are not in (e.g., not registered with, cannot be found in contacts lists or chat groups set up with the second online communication system 106-2, etc.) with the second online chat communication system 106-2.

Any of the third users such as the fifth user operating the fifth user device 108-5, the sixth user operating the sixth user device 108-6, etc., may not be enabled and/or facilitated by the third online chat communication system 106-3 to exchange (e.g., send and/or receive, etc.) online chat communications with the first user operating the first user device 108-1, the second user operating the second user device 108-2, the third user operating the third user device 108-3, the fourth user operating the fourth user device 108-4, the seventh user operating the seventh user device 108-7, etc., as the first user, the second user, the third user, the fourth user, the seventh user, etc., are not in (e.g., not registered with, cannot be found in contacts lists or chat groups set up with the third online communication system 106-3, etc.) with the third online chat communication system 106-3.

2.2. Bridging Between Disparate Chat Systems

Techniques as described herein can be used to break communication barriers between and among disparate online chat communication systems (e.g., 106-1 through 106-3, etc.) owned and/or operated by different entities, including but not necessarily limited to only any of: Slack, WhatsApp, Line, WeChat, Skype, Facebook, Snapchat, Telegram, Viber, Kik, Signal, Microsoft Teams, Stride, TeamSpeak, Samepage, Mumble, and so forth.

These techniques can be applied to creating super chat groups with a chat bridging system (e.g., a cloud-based super chat system, etc.) such as 102 of FIG. 1A with each of the super chat groups comprising super chat group members who are users and/or chat groups in one, two or more different online chat communication systems, even if some or all of these different online chat communication systems do not support online chat communications across boundaries between or among the different online communication systems.

By way of illustration, a (super chat or virtual chat) user can download a chat bridging app (or super chat app) that corresponds, or acts as a corresponding client application, to the chat bridging system 102. Additionally, optionally or alternatively, the user can be registered (e.g., via a web portal, via an app store, via one or more signup webpages, etc.) with the chat bridging system 102 as a registered user. The registered user can then set up or create a super chat group comprising super chat group members who are users and/or chat groups in the different online chat communication systems such as 106-1 through 106-3.

In some embodiments, some or all of the super chat group members may be registered with the chat bridging system 102 as registered users.

In some embodiments, only the user (e.g., a designated user of an enterprise, a system administrator, an authorized person, an authorized user in an organization or enterprise licensing or subscribing to super chat services, etc.) who sets up and/or create the super chat group members registers with the chat bridging system 102. In these embodiments, there is no need for each and every super chat group member to register with the chat bridging system 102.

In some embodiments, any super chat group member in the super chat group regardless of which online chat app is used by such super chat group member and/or regardless of which online chat communication system to which such super chat group member is registered—may be enabled and/or facilitated to exchange online chat communications with any other super chat group member(s) in the same super chat group, regardless of which online chat app(s) are used by such other super chat group member(s) and/or regardless of which online chat communication system(s) to which such super chat group member(s) are registered.

For example, a specific super chat group may be created with the chat bridging system 102 to include the first chat group (e.g., a Slack group, etc.) in the first online chat communication system 106-1 (e.g., Slack system/service, etc.), the second chat group (e.g., a Line group, etc.) in the second online chat communication system 106-2 (e.g., Line system/service, etc.), the third chat group (e.g., a WeChat group, etc.) in the third online chat communication system 106-3 (e.g., WeChat system/service, etc.), etc. Even though a given virtual group user (e.g., a first user, etc.) in the specific super chat group may belong to a specific chat group (e.g., in the Slack group, etc.) in a specific online chat communication system (e.g., the Slack system/service, etc.), under techniques as described herein, such virtual group user (or the first user in the present example) is not limited to use an online chat app (e.g., a Slack app, etc.) corresponding or acting as a client application to the specific online chat communication system (e.g., the Slack system/service, etc.) to exchange online chat communications with other users of the same specific online chat communication system (e.g., the Slack system/service, etc.), but also may exchange online chat communications with other virtual group users (e.g., in the Line group, in the WeChat group, etc.) of the same super chat group who may use different online chat app(s) (e.g., the Line app, the WeChat app, etc.) and/or who are registered to different online chat communication system(s) (e.g., the Line system/service, the WeChat system/service, etc.) as bridged and/or facilitated through the chat bridging system 102.

Thus, once the super chat group is formed or setup, a WeChat user (e.g., operating the fifth user device 108-5, etc.) in the super chat group can post a chat message in a WeChat group that has been included as a part of the super chat group. The chat message will be automatically posted in real time or near real time by a WeChat system (e.g., the third online chart communication system 106-3, etc.) to other WeChat user(s) (e.g., operating the sixth user device 108-6, etc.) in the WeChat group. In addition, the same chat message (or a translated version thereof) will also be automatically posted in real time or near real time by way of the chat bridging system 102 to other user(s) (e.g., users operating the first, second and seventh user devices 108-1, 108-2 and 108-7, users operating the third and fourth user devices 108-4 and 108-5, etc.) in the other chat groups such as one or more Slack groups, one or more Line groups, etc., in the other online chat communication systems such as the Slack system/service (e.g., the first online chat communication system 106-1, etc.), the Line system/service (e.g., the second online chat communication system 106-2, etc.), etc.

### 2.3. Auto Natural Language Translation and Service Adaptation

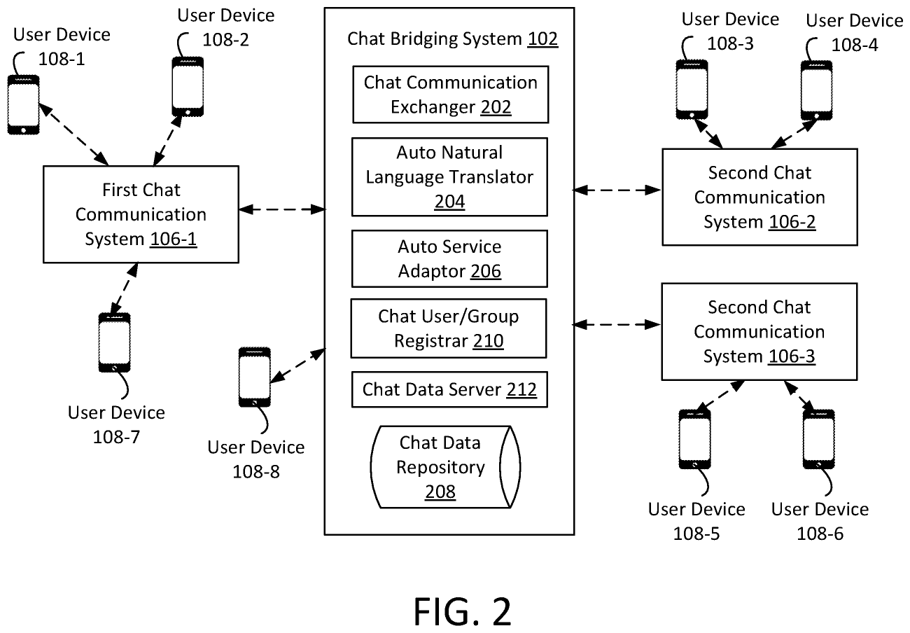

FIG. 2 is an illustrative view of various aspects of an example (e.g., cloud-based, etc.) chat bridging system 102 in which the techniques described herein may be practiced, according to an embodiment. Chat bridging system 102 may be implemented by one or more computing devices. These one or more computing devices comprise any combination of hardware and software configured to implement the various logical components described herein, including components such as a chat communication exchanger 202, an auto natural language translator 204, an auto service adaptor 206, a chat data repository 208, chat user/group registrar 210, chat data server 212, etc. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

The chat bridging system 102 is coupled to online chat communication systems 106-1, 106-2, etc., via one or more computer networks (e.g., 104-1 through 104-3 of FIG. 1A, etc.) such as the Internet.

Via these computer networks, the chat bridging system 102 can interact with user devices to complete user registration procedure(s), set up or create super chat groups, receive, process, generate and/or send online chat communications among super chat group members in a super chat group comprising chat groups in the online chat communication systems 106-1, 106-2, etc.

2.4. User Registration and Super Chat Group Creation

By way of illustration, a (super chat or virtual chat) user operating a user device such as 108-8 can cause a chat bridging app that corresponds, or acts as a corresponding client application, to the chat bridging system 102, to be downloaded (e.g., from the chat bridging system 102, from an app store, etc.) over the computer networks (e.g., 104-1, etc.) and installed on the user device 108-8 and to be running as a mobile app on the user device 108-8.

Additionally, optionally or alternatively, the user may send or initiate a user registration request (e.g., one or more user registration request messages, etc.) to the chat bridging system 102 over the computer networks (e.g., 104-1, etc.).

In response to receiving the user registration request from the user, the chat bridging system 102, or the chat user/group registrar 210 therein, interact and operate with the user device 108-8 to complete a user registration procedure adopted or implemented by the chat bridging system 102. To do so, request and response messages relating to the user registration procedure may be exchanged between the user device 108-8 and the chat user/group registrar 210 over the computer networks (e.g., 104-1, etc.).

Once successfully registered with the chat bridging system 102 as a registered user, the registered user can then set up or create a super chat group comprising super chat group members who are users and/or chat groups in the different online chat communication systems such as 106-1 through 106-3.

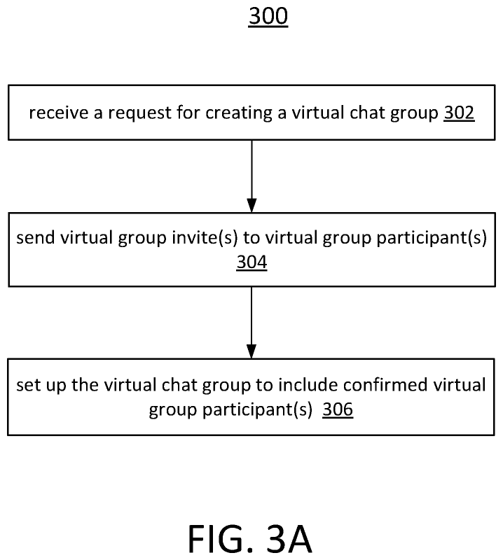

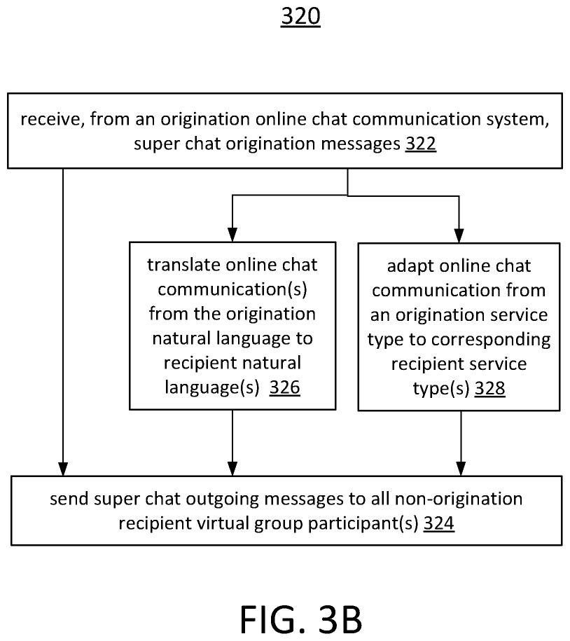

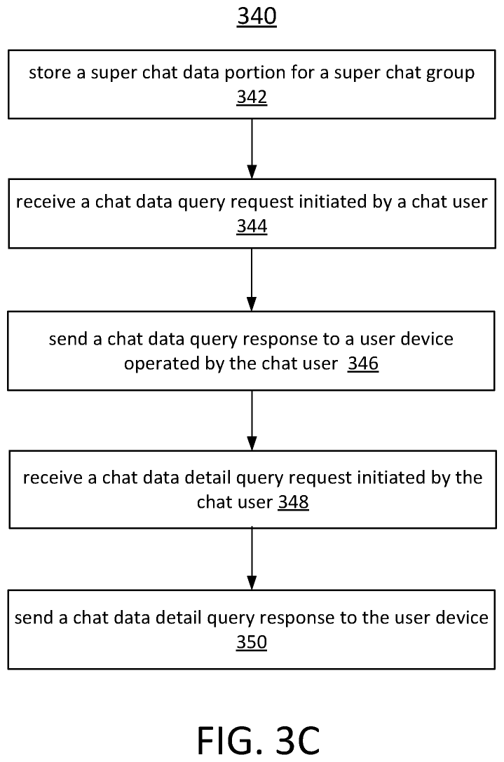

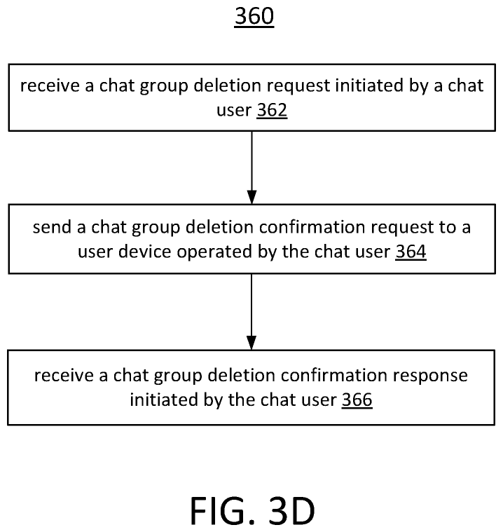

FIG. 3A illustrates an example flow 300 for setting up or creating a super chat group, according to an embodiment. The various elements of flow 300 may be performed in a variety of systems, including a chat user/group registrar (e.g., 210 of FIG. 2, etc.) in a (e.g., cloud-based, etc.) chat bridging system such as 102 of FIG. 1A or FIG. 2 described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer. Flow 300 illustrates but one example flow for setting up or creating a super chat group. Other flows may involve additional or fewer steps, in potentially varying arrangements.

Block 302 comprises receiving a request for creating a super chat group from a user registered with the chat bridging system 102. By way of illustration, the user may use (e.g., tap, touch, click, navigate through, interact with, etc.) one or more specific graphic based controls rendered on one or more display pages of a chat bridging app running on a user device such as 108 of FIG. 1A or FIG. 2 to cause the request for creating the super chat group to be sent to the chat bridging system 102.

In some embodiments, the request for creating the super chat group may include one or more super chat participant identifiers for one or more chat groups/users—which are to be included in the super chat group—in one or more online chat communication systems. In some embodiments, the request for creating the super chat group may include a plurality of super chat participant identifiers for a plurality of chat groups/users—which are to be included in the super chat group—in a plurality of online chat communication systems.

A super chat participant identifier for a chat group or a chat user to be included in the super chat group may include unique chat system identification information for an online chat communication system to which the chat group or the chat user belongs (or is registered, created and/or set up). The unique chat system identification information is capable of being used by the chat bridging system 102, or the chat user/group registrar 210, to fully identify the online chat communication system.

The super chat participant identifier for the chat group or the chat user to be included in the super chat group may also include unique chat group or user identification information for the chat group or the chat user in the online chat communication system.

Block 304 comprises, in response to receiving the request for creating the super chat group, extracting the super chat participant identifier(s) from the request, validating the super chat participant identifier(s), sending virtual group invite(s) (e.g., invite messages, etc.) to virtual group participant(s) as identified by the super chat participant identifier(s), and so forth.

In some embodiments, to validate a (e.g., each, etc.) super chat participant identifier in the request for creating the super chat group, the chat bridging system 102, or the chat user/group registrar 210 therein, may extract unique chat system identification information from the super chat participant identifier, identify an online chat system based on the unique chat system identification information, extract unique chat group or user identification information from the super chat participant identifier, interact with the identified online chat system to determine whether the unique chat group or user identification information is valid or capable of identifying a corresponding chat group or a corresponding chat user in the identified online chat system, etc.

In response to determining that the unique chat group or user identification information is valid or capable of identifying a corresponding chat group or a corresponding chat user in the identified online chat system, the chat user/group registrar 210 in the chat bridging system 102 can interact with the identified online chat system to identify the corresponding chat group or the corresponding chat user, send a virtual group participant invite (e.g., one or more messages, etc.) to the corresponding chat group or the corresponding chat user, etc.

In response to receiving the virtual group participant invite from the chat bridging system 102 by way of the identified online chat communication system, a designated user (e.g., creator, an authorized user, an authorized user in an organization or enterprise licensing or subscribing to super chat services, etc.) of the corresponding chat group or the corresponding chat user can send a virtual group participant invite response (e.g., acceptance, denial, as a response to the virtual group participant invite, etc.) by way of the identified online chat communication system to the chat user/group registrar 210 in the chat bridging system 102.

The foregoing operations may be repeated for each super chat participant identifier in the request for creating the super chat group.

Block 306 comprises, in response to receiving virtual group participant invite response(s), determining whether any of the received virtual group participant invite response(s) is an acceptance/confirmation) or a denial/rejection. In response to determining that at least one of the received virtual group participant invite response(s) is an acceptance/confirmation, the chat user/group registrar 210 in the chat bridging system 102 sets up or creates the super chat group as requested by the user in block 302.

Furthermore, in response to determining that a (e.g., each, etc.) virtual group participant invite response in the received virtual group participant invite response(s) is an acceptance/confirmation, the chat user/group registrar 210 in the chat bridging system 102 causes the super chat group to include a corresponding chat group or a chat user from which the acceptance/confirmation is received in this virtual group participant invite response.

On the other hand, in response to determining that a (e.g., each, etc.) virtual group participant invite response in the received virtual group participant invite response(s) is a denial/rejection, the chat user/group registrar 210 in the chat bridging system 102 causes the super chat group to exclude a corresponding chat group or a chat user from which the denial/rejection is received in the virtual group participant invite response.

2.5. Chat Exchange, Auto Tranlation and Service Adaptation

FIG. 3B illustrates an example flow 320 for exchanging chat communications in a super chat group or one or more super chat participants in a super chat group, according to an embodiment. The various elements of flow 320 may be performed in a variety of systems, including the chat communication exchanger 202, auto natural language translator 204, auto service adaptor 206, etc., in a (e.g., cloud-based, etc.) chat bridging system 102 such as described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer. Flow 320 illustrates but one example flow for exchanging chat communications in a super chat group or one or more super chat participants in a super chat group. Other flows may involve additional or fewer steps, in potentially varying arrangements.

Block 322 comprises receiving, from an origination online chat communication system (e.g., the third online chat communication system 106-3, etc.), one or more super chat origination messages including but not limited to an online chat communication destined for a super chat group or one or more specific recipient super chat participants in the super chat group, which super chat group may have been set up using the flow 300 of FIG. 3A as illustrated above with the chat bridging system 102. A super chat participant in a super chat group may refer to a specific chat user who are included in the super chat group, or to a specific (e.g., chat-system-specific, Slack, Line, WeChat, etc.) chat group who are included in the super chat group.

The online chat communication may be originated in the origination online chat communication system by an origination super chat user in the super chat group. The origination super chat user may be a registered user (e.g., a WeChat user, etc.) of the third online chat communication system 106-3 (e.g., a WeChat system, etc.). The WeChat user (or the origination super chat user) can interact with a WeChat app running on the user device 108-5 to use (e.g., tap, touch, click, navigate through, interact with, etc.) one or more specific graphic based controls rendered on one or more display pages of the WeChat app to view and select the super chat group (for receiving the online chat communication) among one or more chat groups displayed by the WeChat app.

Additionally, optionally or alternatively, the WeChat user can use (e.g., tap, touch, click, navigate through, interact with, etc.) one or more specific graphic based controls rendered on one or more display pages of the WeChat app to drill down and select the one or more specific super chat participants (for receiving the online chat communication) in the super chat group. In some embodiments, other participants (not included in the one or more specific super chat participants) in the super chat group may not receive the online chat communication.

Once the super chat group or the one or more recipient super chat participants in the super chat group are identified to receive the online chat communication, the WeChat user can use (e.g., tap, touch, click, navigate through, interact with, etc.) one or more specific graphic based controls rendered on one or more display pages of the WeChat app to cause the online chat communication to be generated, sent and/or originated from the user device 108-5 to the WeChat system (or the third online chat communication system 106-3). An example online chat communication as described herein may include, but are not necessarily limited to only, one or more of: texts, hyperlinks, images, audio, videos, documents, and so forth.

Upon receiving the online chat communication from the user device 108-5 in real time or near real time, the WeChat system (or the third online chat communication system 106-3) can forward the online chat communication to any WeChat participant(s) such as individual WeChat users, individual WeChat groups, etc., that are found or identified among the one or more recipient super chat participants.

Additionally, optionally or alternatively, the WeChat system (or the third online chat communication system 106-3) can determine whether the online chat communication from the WeChat user is destined for at least one super chat participant (at least one non-WeChat participant) outside the WeChat system.

In response to determining that the online chat communication is destined for at least one super chat participant (at least one non-WeChat participant) outside the WeChat system, the WeChat system can further send the one or more super chat origination messages including but not limited to the online chat communication to the chat bridging system 102 for further processing. Additionally, optionally or alternatively, the one or more super chat origination messages sent from the WeChat system to the chat bridging system 102 includes super chat identification information including super chat participant identifier(s) for some or all of the origination super chat user and the one or more recipient super chat participants.

In block 322, the chat bridging system 102 can extract the (e.g., non-WeChat, etc.) recipient super chat participant identifier(s) from the one or more super chat origination messages. The chat bridging system 102, or the chat communication exchanger 202 therein, may extract unique recipient chat system identification information from a recipient super chat participant identifier, identify a recipient online chat system based on the unique recipient chat system identification information, extract unique recipient chat group or user identification information from the recipient super chat participant identifier, etc.

Block 324 comprises sending one or more super chat outgoing messages including but not limited to the online chat communication to all (e.g., non-WeChat, etc.) recipient virtual group participant(s) as identified by the (e.g., non-WeChat, etc.) recipient super chat participant identifier(s) in all non-recipient online chat communication system(s), and so forth.

For example, the chat bridging system 102 can send the one or more super chat outgoing messages including but not limited to the online chat communication to a corresponding non-WeChat recipient virtual group participant as identified by the (e.g., non-WeChat, etc.) recipient super chat participant identifier in a non-recipient online chat communication system (e.g., the first online chat communication system 106-1 or the Slack system, the second online chat communication system 106-2 or the Line system, etc.), etc.

The foregoing operations may be repeated for each (e.g., non-WeChat, etc.) recipient super chat participant identifier in the one or more super chat outgoing messages from the origination online chat communication system (the WeChat system in the present example).

In some embodiments, the process flow 320 can go from block 322 to block 324 without involving blocks 326 and 328, for example in operational scenarios in which neither auto natural language translation nor auto service adaptation is performed.

In some embodiments, the process flow 320 can (e.g., immediately, etc.) go from block 322 to block 326 and then to block 324, for example in operational scenarios in which auto natural language translation but not auto service adaptation is performed.

In some embodiments, the process flow 320 can (e.g., immediately, etc.) go from block 322 to block 328 and then to block 324, for example in operational scenarios in which auto service adaptation but not auto natural language translation is performed.

In some embodiments, the process flow 320 can (e.g., immediately, etc.) go from block 322 to blocks 326 and 328 (e.g., performed in parallel, in series, in part parallel in part series, etc.) and then to block 324, for example in operational scenarios in which both auto natural language translation and auto service adaptation are performed.

In some operational scenarios, the super chat group may comprise participants who reads or speaks two or more different natural languages (e.g., English, Chinese, Dutch, French, etc.). The chat bridging system 102, or the auto natural language translator 204 therein, may apply natural language processing and convert, transform or translate origination online communications (e.g., text, voice, etc.) from an origination natural language to recipient natural languages supported or preferred by a recipient online chat communication system or a recipient super chat participant therein, for example in a realtime super chat session exchanging realtime texts, voice or video information.

Block 326 comprises extracting the online chat communication (e.g., a WeChat text in Chinese, etc.) from the one or more super chat origination messages, identifying an origination natural language (e.g., Chinese, etc.) in which the online chat communication is (e.g., entirely, mostly, etc.) represented or composed, converting, identifying recipient natural languages (e.g., Chinese, English, Dutch, French, etc.) of the (e.g., non-WeChat, etc.) recipient super chat participant(s), transforming or otherwise translating the online chat communication from the origination natural language (Chinese in the present example) to any recipient natural language(s) (English, Dutch, French, etc., in the present example) that are different from the origination natural language (Chinese in the present example), and so forth.

The online chat communication in the recipient natural language(s), in addition to or in place of the online chat communication in the origination natural language, may be provided to block 324 for inclusion as the online chat communication in the one or more super chat outgoing messages to recipient super chat participant(s) who use or prefer the recipient natural language(s) that are different from the origination natural language.

In some operational scenarios, the super chat group may comprise participants in online chat communication systems that support different services or different service features. By way of illustration but not limitation, the origination online chat communication system (the WeChat system in the present example) may implement chat related services or service features to support voice or video calls, whereas at least one of the recipient online chat communication system(s) may not implement chat related services or service features to support voice or video calls.

The chat bridging system 102, or the auto service adaptor 206 therein, may apply natural language processing and convert, transform or adapt origination voice or video call communications from an origination online chat communication system to non-voice-non-video texts supported by a recipient online chat communication system, for example in a realtime super chat session intended to be a realtime voice or video call session. Conversely, the chat bridging system 102 may apply natural language synthesizing and convert, transform or adapt origination non-voice-non-video texts voice or video call communications from an origination online chat communication system to supported by a recipient online chat communication system, for example in the same realtime super chat session.

By way of example but not limitation, the online chat communication as described herein may be a voice or video chat communication in a realtime super chat session (e.g., similar to a WeChat voice or video call, similar to a Skype voice or video call, etc.).

Block 328 comprises extracting the online chat communication from the one or more super chat origination messages, determining an origination service type or service feature type (e.g., a WeChat voice or video call service type or service feature type, etc.) based at least in part on the extracted online chat communication (e.g., the online chat communication comprising voice or video call data, etc.), determining recipient service type(s) or service type(s) (e.g., designated to be corresponding to or interfacing with the origination service type or service feature, non-voice-non-video chat texts, etc.) associated with recipient super chat participant(s), converting, transforming or otherwise adapting the online chat communication from the origination service type or service feature (the WeChat voice or video call service type or service feature in the present example) to the corresponding recipient service type(s) or service feature(s) (non-voice-non-video chat texts in the present example) that are different from the origination service type or service feature (the WeChat voice or video call service type or service feature in the present example), and so forth.

The online chat communication as adapted for the corresponding recipient service type or service feature, in addition to or in place of the online chat communication in the origination service type or service feature, may be provided to block 324 for inclusion as the online chat communication in the one or more super chat outgoing messages to recipient super chat participant(s) in recipient online chat communication system(s) that do not support the origination service or service feature.

2.6. Chat Related Services

A (e.g., cloud-based, etc.) chat bridging system such as 102 of FIG. 1A or FIG. 2 described herein can (e.g., concurrently, simultaneously, etc.) support multitasking and/or multiple services and/or multiple system functions with multiple super chat groups and/or multiple online chat communication systems. By way of example, a plurality of super chat sessions of various types (e.g., text only, voice, video, document exchange, image sharing, etc.) involving disparate online chat communication systems that by themselves cannot support chat sessions across different online chat communication systems can be (e.g., concurrently, simultaneously, etc.) supported and handled by the chat bridging system 102 operating with the disparate online chat communication systems.

Under techniques as described herein, a chat user of an online chat communication system, whether registered with the chat bridging system 102 or with an online chat communication system interfacing/operating with the chat bridging system 102, can automatically gain an ability to communicate to chat with chat groups/users (or participants) in other online chat communication system by way of being included in a super chat group. Thus, the user does not have to change communication habits or alter social/network environments in order to perform online chat operations such as super chat operations, super chat operations, etc., with other chat users who may be in different online chat communication systems.

Additionally, optionally or alternatively, to invoke (e.g., cloud-based, etc.) super chat services as described herein, the chat user does not have to download, install and/or run a super chat application that corresponds to or acts as a client app to the chat bridging system 102. The chat user can very well use a favorite (or personally accustomed) chat app such as a Slack app, a Line app, WeChat app, etc., based on the chat user's own communication habits and/or social/network environments to invoke any of these super chat services.

Additionally, optionally or alternatively, the chat bridging system 102 can monitor a chat session in real time or near real time, provide service options and/or upgrades and/or updates in real time or near real time to some or all super chat participants in a super chat session, and so forth.

In some embodiments, the chat bridging system 102 may be implemented with a virtual private network that connect among different regions and/or different computer (or communication) networks. Even where firewalls with various access controls/restrictions may have been implemented between some or all of these different regions and/or different computer networks, the chat bridging system 102 can use the virtual private network to penetrate/bypass these firewalls and allow chat users located in these different regions and/or different computer networks to exchange online chat communications without being restricted by the firewalls.

In some embodiments, a chat user (e.g., operating with the user device 108-8 of FIG. 1A or FIG. 2, etc.) may not need to sign up with or run a chat app corresponding to any of online chat communication systems operating with the chat bridging system 102 in order for the chat user to exchange online chat communications with other chat users. As illustrated in FIG. 1A and FIG. 2, the chat user can operate the user device 108-8 to download, to the user device 108-8, a super chat app corresponding to the chat bridging system 102 and cause the super chat app to be running on the user device 108-8. Through the super chat app, the chat user can communicate or interact with the (e.g., cloud-based, etc.) chat bridging system 102 to set up or create chat group(s) including but not limited to super chat group(s) across chat system/app boundaries, regional boundaries, communication network boundaries, firewalls. Through the super chat app, the chat user can communicate or interact with the (e.g., cloud-based, etc.) chat bridging system 102 to exchange online chat communications with other super chat users as well as other chat users of other online chat communication systems. Through the super chat app, the chat user can communicate or interact with the (e.g., cloud-based, etc.) chat bridging system 102 to browse and search super chat data maintained by the chat bridging system 102. Thus, techniques as described herein can be used to enable a chat user to run one chat app (e.g., the super chat app, etc.) and exchange online chat communications with any other chat users regardless of which chat app is used by the other chat users, regardless of where the other chat users are located, etc.

Super chat groups, which are created or set up with the chat bridging system 102, can be assigned with unique super chat group identifiers each of which uniquely identifies a respective super chat group (e.g., a virtual chat group, a cross-system chat group, a chat group set up with the chat bridging system 102, etc.) among the super chat groups. A super chat group may comprise a single participant such as a single chat user or group in an online chat communication system or may comprise multiple participants such as multiple users and/or multiple chat groups in an online chat communication system. Communications between the chat bridging system 102 and an online chat communication system can be (e.g., transparently, through a multi-regional and/or multi-network VPN, through a firewall-penetrating/bypassing VPN, with no or little user devices' involvement or knowledge, etc.) performed through APIs (e.g., Slack APIs, Line APIs, WeChat APIs, super chat APIs, etc.) provided or implemented by one or both of the chat bridging system 102 and the online chat communication system.

Teams in a single enterprise or multiple enterprises, single region or multiple regions as well as individual users and/or individual chat groups can form super chat groups without any language, firewall and/or chat app barriers. By way of illustration, an individual chat user—who uses a Slack app for online chatting and is a registered user of, or a subscriber to super chat services offered/provided by, the chat bridging system 102—may meet another individual chat user (e.g., a foreign visitor, etc.) who uses a Line app for online chatting. Under techniques as described herein, one or both of the individual chat users, if authorized to access the super chat services offered/provided by the chat bridging system 102, can initiate and form a super chat group through the chat bridging system 102 to include both of the individual users. In the present example, the Slack user who is a registered user or a subscriber to services offered/provided by the chat bridging system 102 can access the chat bridging system to create the super chat group in real time or near real time. After the super chat group is formed, these individual chat users can use their respective favorite chat apps to exchange online chat communications with each other, without language, firewall and/or chat app barriers. These online chat communications can be exchanges through a VPN implemented with the (e.g., cloud-based, etc.) chat bridging system 102.

2.7. Chat Data Services

In addition to supporting super chat services, auto natural language translation, auto service adaptation, super chat monitoring, and so forth, the chat bridging system 102, or the chat data server 212 therein, may store some or all super chat data (including any attendant data thereof) in a chat data repository (e.g., 208 of FIG. 2, etc.). Example super chat data may include, but not is not necessarily limited to only, some or all of: chat communications (e.g., texts, audio, video, documents, etc.), their derivatives (e.g., translated text chats, service adapted chat communication, etc.), super chat user registration information, super chat group configuration information, super chat session information, timing information of sending and receiving chat communications, origination chat user information, origination online chat communication system information, recipient chat participant information, recipient online chat communication system information, and so forth.

The super chat data stored or maintained in the chat data repository 208 can be organized with one or more of many different methods such as relational data store methods, non-relational data store methods, object data store methods, non-object data store methods, file-based methods, non-file-based methods, distributed data store methods, index-based methods, dictionary-based methods, keyword-based methods, user-input-based methods, non-user-input-based methods, and so forth. Any chat communications including but not limited to any documents may be searched or searchable through virtual data access application programming interfaces or APIs. Thus, even where an online chat communication system such as the WeChat system does not keep documents beyond a limited set time period, a chat user included in a super chat group registered with the chat bridging system 102 can access any of these documents using the virtual data APIs beyond the limited set time period. Additionally, optionally or alternatively, a chat user can organize the super chat data in a particular manner selected by the chat user. The super chat data can be organized, relatively easily searchable or browsable, stored permanently or with a relatively long time period longer than an expiration period of an online chat communication system operating with the chat bridging system 102, etc.

For example, an up-to-date (e.g., permanent, etc.) record of all chat communications in a super chat group may be maintained as super chat data by the chat bridging system 102. By querying and accessing some or all of the up-to-date record of chat communications occurred in the super chat group from the super chat data by way of the chat data server 212 in the chat bridging system 102, any inventive ideas discussed among a multi-national collaborative team of a multi-national enterprise (e.g., Ericsson, Cisco, Microsoft, Google, etc.) can be traced. Any tasks that have been discussed by the super chat group can be properly tracked and scheduled.

FIG. 3C illustrates an example flow 340 for supporting searching/browsing super chat data, according to an embodiment. The various elements of flow 340 may be performed in a variety of systems, including the chat communication exchanger 202, auto natural language translator 204, auto service adaptor 206, the chat data server 212, etc., in a (e.g., cloud-based, etc.) chat bridging system 102 such as described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer. Flow 340 illustrates but one example flow for supporting searching/browsing super chat data. Other flows may involve additional or fewer steps, in potentially varying arrangements.

Block 342 comprises storing, by the chat data server 212 into the chat data repository 210, a super chat data portion including but not limited to some or all of an up-to-date (e.g., permanent, concurrent, a realtime updated, a near realtime updated, etc.) record of all chat communications in a super chat group, may have been set up using the flow 300 of FIG. 3A as illustrated above with the chat bridging system 102.

Block 344 comprises receiving, by the chat data server 212, a chat data query request initiated by a chat user (e.g., a user operating the user device 108-8 running a chat app corresponding to the chat bridging system, a user operating the user device 108-1 running a chat app corresponding to the online chat communication system 106-1, etc.) in the chat bridging system 102 or in an online chat communication system. The chat data query request may be received by the chat data server 212 directly (e.g., from the user device 108-8, etc.) or by way of the online chat communication system (e.g., 106-1, etc.). The chat data query request may comprise a super chat group identifier, which can be extracted or used by the chat data server 212 to identify a super chat group.

Block 346 comprises sending, by the chat data server 212, a chat data query response to the user device used by the chat user to initiate the chat data query request. The chat data query response may be sent to the user device (e.g., the user device 108-8, the user device 108-1, etc.) directly from the chat data server 212 or by way of the online chat communication system (e.g., 106-1, etc.). The chat data server 212 may include, in the chat data query response, a chat data description for the super chat data portion including but not limited to some or all of the up-to-date record of all chat communications in the super chat group.

On receiving the chat data query response, the user device may retrieve the chat data description and (e.g., textually, graphically, etc.) present or render some or all of the chat data description on one or more display pages on a user interface of the user device. The chat data description may depict or specify some or all of online communications (e.g., texts, audios, videos, images, documents, etc.) have been exchanged among super chat participants int the super chat group, chat-related timing information, chat-related derived information (e.g., information annotated by users, information gained through machine learning, etc.), chat group participants' information, etc.

Block 348 comprises receiving, by the chat data server 212, a chat data detail query request initiated by the chat user. The chat data detail query request may be received by the chat data server 212 directly (e.g., from the user device 108-8, etc.) or by way of the online chat communication system (e.g., 106-1, etc.). The chat data detail query request may comprise the super chat group identifier as well as any additional query criteria (e.g., a particular chat user, a particular date, a particular topic, etc.), query predicates (e.g., query conditions, Boolean logic expressions, etc.), etc.

Block 350 comprises sending, by the chat data server 212, a chat data detail query response to the user device used by the chat user to initiate the chat data detail query request. The chat data detail query response may be sent to the user device (e.g., the user device 108-8, the user device 108-1, etc.) directly from the chat data server 212 or by way of the online chat communication system (e.g., 106-1, etc.). The chat data server 212 may include, in the chat data query response, some or all of the super chat data portion that satisfies the additional query criteria, is responsive to the query predicates, etc. On receiving the chat data detail query response, the user device may retrieve the super chat data portion and (e.g., textually, graphically, etc.) present or render some or all of the chat data portion on one or more display pages on a user interface of the user device.

In various embodiments, the process flow 340 may be augmented to support additional functionality such as data caching in cloud, data storing in cloud, searching/browsing super chat data in different ways, performing value added operations such as AI-based machine learning, etc.

2.8. Tearing Down Super Chat Groups

After a super chat group is created or set up, the super chat group can be browsed (e.g., display a list of current and/or former participants, display a list of current and/or former online chat communication systems involved in the super chat group, etc.), modified (e.g., adding participant(s) to the super chat group, removing participant(s) from the super chat group, and/or deleted from the chat bridging system 102.

FIG. 3D illustrates an example flow 360 for tearing down or deleting a super chat group (e.g., at any time, at a scheduled time, etc.), according to an embodiment. The various elements of flow 360 may be performed in a variety of systems, including the chat communication exchanger 202, auto natural language translator 204, auto service adaptor 206, the chat data server 212, etc., in a (e.g., cloud-based, etc.) chat bridging system 102 such as described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer. Flow 360 illustrates but one example flow for tearing down or deleting a super chat group. Other flows may involve additional or fewer steps, in potentially varying arrangements.

Block 362 comprises receiving, by the chat user/group registrar 210, a chat group deletion request initiated by a chat user (e.g., a user operating the user device 108-8 running a chat app corresponding to the chat bridging system, etc.) in the chat bridging system 102. The chat data query request may comprise a super chat group identifier, which can be extracted or used by the chat data server 212 to identify a super chat group.

Block 364 comprises sending, by the chat user/group registrar 210, a chat group deletion confirmation request to the user device used by the chat user to initiate the chat group deletion request. The chat user/group registrar 210 may include, in the chat group deletion confirmation request, a chat group description including but not limited to some or all of super chat participant information for the super chat group.

On receiving the chat group deletion confirmation request, the user device may retrieve the chat group description, (e.g., textually, graphically, etc.) present or render some or all of the chat group description on one or more display pages on a user interface of the user device and request the user to confirm deleting the super chat group.

Block 366 comprises receiving, by the chat user/group registrar 210, a chat group deletion confirmation response initiated by the chat user. The chat group deletion confirmation response may incorporate, or may be generated based on, user input specifying whether the super chat group is confirmed to be deleted. In response to determining, based on the chat group deletion confirmation response, that the super chat group is confirmed to be deleted, the chat user/group registrar 210 may delete, or move to a deleted state, the super chat group. Otherwise, the chat user/group registrar 210 abort any operation to delete the super chat group from the chat bridging system 102.

2.9. Presence and Intention

Super chat techniques as described herein can be used to enable asynchronous and synchronous communications through realtime tracking of presence and/or intent information of users. A realtime collective framework may be set up to utilize various sensor inputs, inputs from human and non-human endpoint devices (including but not limited to those communicating with IOT sensors), etc., to collect, analyze and determine (e.g., communication, contextual, etc.) presence and intention information.

Some or all of the (contextual) presence and intention information can be incorporated in a global communications system used by communication participants in many different geographic locations, continents, countries, regions, cities, venues, etc. The global communication system may be virtually built over one or more of: chat systems, video conferencing systems, home gateway systems etc.

FIG. 1B is an illustrative view of various aspects of an example system 100-1 in which the techniques described herein may be practiced, according to an embodiment. System 100-1 comprises one or more computing devices. The one or more computing devices comprise any combination of hardware and software configured to implement the various logical components described herein, including components such as chat bridging system 102, first chat communication system 106-1, second chat communication system 106-2, third chat communication system 106-3, user devices 108-1 through 108-8, IoT devices 110-1 through 110-3, and so forth. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

The chat bridging system (102) may be (e.g., virtually, etc.) connected with some or all of other devices or systems such as user devices, IoT devices (e.g., 110-1 through 110-3, etc.), home gateway systems, chat systems, video conferencing systems, etc., over one or more computer networks (e.g., 104-1 through 104-3, etc.).

Up-to-date information about presences and/or intents of person(s) or other communication parties/groups may be collected and/or derived by the chat bridging system (102) from some or all of these other devices or systems. Some or all of a wide variety of inputs of information—such as user, device and system activity information, user and device location, interactions between and among devices, users, systems, etc., network participation/activity information, sensor collected data, and so forth—may be collected, analyzed and intelligently calculated for the purpose of collecting and/or deriving some of all of the information about presence and/or intents.

Face detection information, touch sensor information, movement sensor information, gesturing sensor information including but not limited to hand gesturing information, device information, mobile application status information, etc., may be collected by way of user devices, IOT devices, wearable devices, head-mounted devices, home gateway systems, conferencing systems, etc., and analyzed through artificial intelligence (AI) or non-AI techniques, machine learning (ML) or non-ML techniques, etc., to determine whether any communication participant is actually present for chat communications or non-chat communications. Any of the collected information and results of analyses based on the collected information can be exchanged and/or shared with other communication systems, other chat system, etc. Additionally, optionally or alternatively, some or all of the collected information and the results of analyses may be used to determine an intent of a communication participant such as whether the communication participant is reaching out to order an airplane ticket, to determine a movie to watch, to get information for a social event, to seek assistance on a specific problem, etc.

The information about presences and/or intents may be used to influence workflows in chat communications or other communication channels/services and to improve asynchronous and synchronous communication.

The chat bridging system (102) or a system operating in conjunction with the chat bridging system (102) may determine priority or urgency of a communication and route or re-route the communication over an available communication channel (e.g., a 911 call, etc.) instead of exclusively relying on a chat communication channel.

A system as described herein can implement or incorporate features for supporting presence and intentional communications based on presence and/or intention information. The system can provide additional UI information used to initiate communication. The presence and/or intent information can be used to alter user interface presentations. For example, a communication participant can be enabled to engage in synchronous communications automatically over an available communication channel including but not limited to only a chat communication channel, without needing to touch a special control or button to initiate such synchronous communications.

Visual/audio UI indicators (e.g., as a part of a chat user interface, etc.) may be used to indicate some or all information about presences and/or intents of one or more communication participants to other communication participants. The UI indicators may indicate that the one or more communication participants are actually present at virtual offices in real time. Thus, instead of sending asynchronous messages (e.g., asynchronous text chats, audio chats, video chats, etc.) to be answered by recipients at any later times, synchronous communications (e.g., synchronous text chats, audio chats, video chats, etc.) can be conveyed to and received by the communication participants from the other communication participants.

The system can utilize surrounding networks, system gateways to aggregate and analyze human communication intentions without needing to initiate “handshake confirmations” and to predict presences and/or intentions in order to enhance synchronous and asynchronous communications across realtime communication frameworks/networks/services.

A presence and/or intention aware communication platform implemented using some or all of the techniques as described herein can be integrated into other communications systems thus streamlining all forms of networked communication applications and systems including but not necessarily limited to those related to video conferencing, online chat, voice communications, computer games, etc. Communications become more natural and seamless than otherwise. For example, unnecessary “notifications”, “pre-communication”, “handshake initiation”, etc., expressly used to ascertain or establish presences and intentions can be filtered out and largely avoided, as the presence and intention information is automatically determined or established based on sensory data and other information collected in realtime under techniques as described herein.

Some example benefits under techniques as described herein include but are not necessarily limited to only: contextual communications incorporating automatically determined presences/intents among users without using unnecessary notifications/steps to expressly ascertain the presences/intents of the users, applying information about the presences/intents to improving all forms of communication by eliminating extra notifications/steps overheads, improving and shortening time to initiate communications and to establish contact, and so forth.

### 3.0. Example Embodiments

Examples of some embodiments are represented, without limitation, in the following paragraphs:

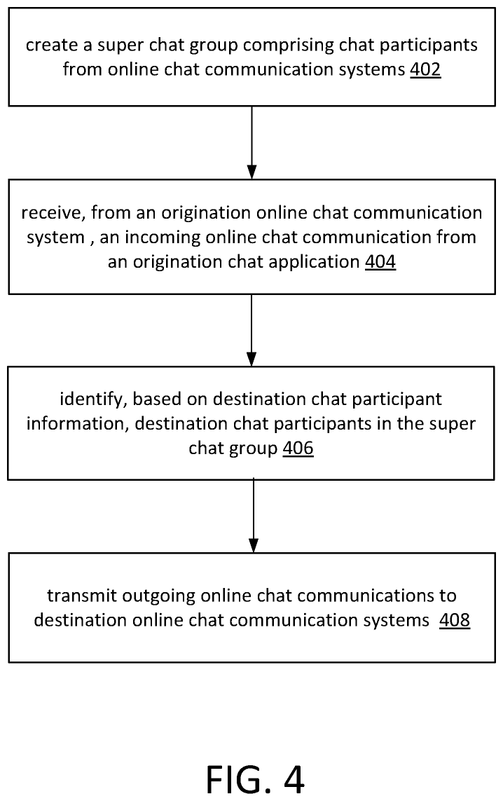

FIG. 4 illustrates an example process flow that may be implemented by one or more computing devices such as a chat bridging system 102 of FIG. 1A or FIG. 2, or one or more subsystems therein, etc., as described herein. In block 402, the system creates a super chat group comprising a plurality of chat participants from a plurality of online chat communication systems. Each chat participant in the plurality of chat participants uses a respective chat application in a plurality of chat applications. Each chat application in the plurality of chat applications corresponds to a respective online chat communication system in the plurality of online chat communication systems.

In block 404, the system receives, from an origination online chat communication system in the plurality of online chat communication systems, an incoming online chat communication from an origination chat application operated by an origination chat participant in the plurality of chat participants in the super chat group.

In block 406, the system identifies, based at least in part on destination chat participant information received with the incoming online chat communication, one or more destination chat participants in the plurality of chat participants in the super chat group.

In block 408, the system transmits one or more outgoing online chat communications to one or more destination online chat communication systems to which one or more destination chat applications operated by the one or more destination chat participants correspond. Each of the one or more outgoing online chat communication is generated from the incoming online chat communication.

In an embodiment, at least one of the one or more outgoing online chat communications is generated with automatic natural language translation from the incoming online chat communication.

In an embodiment, at least one of the one or more outgoing online chat communications is generated with automatic service adaptation from the incoming online chat communication.

In an embodiment, the plurality of online chat communication systems comprises one or more of: Slack, WhatsApp, Line, WeChat, Skype, Facebook, Snapchat, Telegram, Viber, Kik, Signal, Microsoft Teams, Stride, TeamSpeak, Samepage, Mumble, and so forth.

In an embodiment, the online chat communication comprises one or more of: texts, hyperlinks, images, audio, videos, documents, etc.

In an embodiment, the system is further configured to perform: storing a complete record of online chat communications in the super chat group since the super chat group is created; allowing one or more users to access at least a portion of the complete record of online chat communications in the super chat group.

In an embodiment, the system is further configured to perform: storing automatically determining presences of one or more communication participants based at least in part on collected sensory data from one or more of: human operated user devices, non-human internet-of-things (IoT) devices, or sensors; enabling synchronous communication between at least two communication participants based on the automatically determined presences of the one or more communication participants.

In an embodiment, the foregoing is performed by a chat bridging system; the super chat group includes at least on chat participant who operates a chat application corresponding to the chat bridging system.

Other examples of these and other embodiments are found throughout this disclosure.

### 4.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

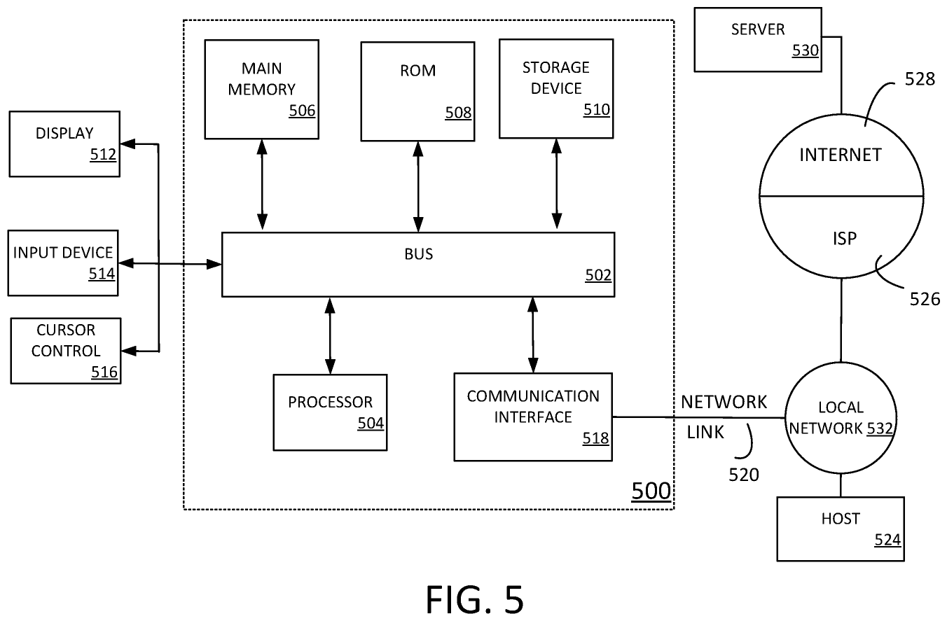

FIG. 5 is a block diagram that illustrates a computer system 500 utilized in implementing the above-described techniques, according to an embodiment. Computer system 500 may be, for example, a desktop computing device, laptop computing device, tablet, smartphone, server appliance, computing main image, multimedia device, handheld device, networking apparatus, or any other suitable device.

Computer system 500 includes one or more busses 502 or other communication mechanism for communicating information, and one or more hardware processors 504 coupled with busses 502 for processing information. Hardware processors 504 may be, for example, a general purpose microprocessor. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes a main memory 506, such as a random access memory (RAM) or other dynamic or volatile storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, is provided and coupled to bus 502 for storing information and instructions.

Computer system 500 may be coupled via bus 502 to one or more displays 512 for presenting information to a computer user. For instance, computer system 500 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

In an embodiment, output to display 512 may be accelerated by one or more graphics processing unit (GPUs) in computer system 500. A GPU may be, for example, a highly parallelized, multi-core floating point processing unit highly optimized to perform computing operations related to the display of graphics data, 3D data, and/or multimedia. In addition to computing image and/or video data directly for output to display 512, a GPU may also be used to render imagery or other video data off-screen, and read that data back into a program for off-screen image processing with very high performance. Various other computing tasks may be off-loaded from the processor 504 to the GPU.

One or more input devices 514 are coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

A computer system 500 may implement techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 506, from which processor 504 retrieves and executes the instructions. The instructions received by main memory 506 may optionally be stored on storage device 510 either before or after execution by processor 504.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as a 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send messages and receive data, including program code and/or other types of instructions, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

In an embodiment, some or all of the systems described herein may be or comprise server computer systems, including one or more computer systems 500 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 5.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
creating a super chat group comprising a plurality of chat participants from a plurality of online chat communication systems, wherein each chat participant in the plurality of chat participants uses a respective chat application in a plurality of chat applications, wherein each chat application in the plurality of chat applications corresponds to a respective online chat communication system in the plurality of online chat communication systems;
receiving, from an origination online chat communication system in the plurality of online chat communication systems, an incoming online chat communication from an origination chat application operated by an origination chat participant in the plurality of chat participants in the super chat group;
identifying, based at least in part on destination chat participant information received with the incoming online chat communication, one or more destination chat participants in the plurality of chat participants in the super chat group;
transmitting one or more outgoing online chat communications to one or more destination online chat communication systems to which one or more destination chat applications operated by the one or more destination chat participants correspond, wherein each of the one or more outgoing online chat communication is generated from the incoming online chat communication.

2. The method of claim 1, wherein at least one of the one or more outgoing online chat communications is generated with automatic natural language translation from the incoming online chat communication.

3. The method of claim 1, wherein at least one of the one or more outgoing online chat communications is generated with automatic service adaptation from the incoming online chat communication.

4. The method of claim 1, wherein the plurality of online chat communication systems comprises one or more of: Slack, WhatsApp, Line, WeChat, Skype, Facebook, Snapchat, Telegram, Viber, Kik, Signal, Microsoft Teams, Stride, TeamSpeak, Samepage, or Mumble.

5. The method of claim 1, wherein the online chat communication comprises one or more of:
texts, hyperlinks, images, audio, videos, or documents.

6. The method of claim 1, further comprising:
storing a complete record of online chat communications in the super chat group since the super chat group is created;
allowing one or more users to access at least a portion of the complete record of online chat communications in the super chat group.

7. The method of claim 1, wherein the method is performed by a chat bridging system, and wherein the super chat group includes at least on chat participant who operates a chat application corresponding to the chat bridging system.

8. The method of claim 1, further comprising:
automatically determining presences of one or more communication participants based at least in part on collected sensory data from one or more of: human operated user devices, non-human internet-of-things (IoT) devices, or sensors;
enabling synchronous communication between at least two communication participants based on the automatically determined presences of the one or more communication participants.

9. A non-transitory computer readable medium that stores computer instructions which, when executed by one or more computing processors, cause the one or more computing processors to perform:
creating a super chat group comprising a plurality of chat participants from a plurality of online chat communication systems, wherein each chat participant in the plurality of chat participants uses a respective chat application in a plurality of chat applications, wherein each chat application in the plurality of chat applications corresponds to a respective online chat communication system in the plurality of online chat communication systems;
receiving, from an origination online chat communication system in the plurality of online chat communication systems, an incoming online chat communication from an origination chat application operated by an origination chat participant in the plurality of chat participants in the super chat group;
identifying, based at least in part on destination chat participant information received with the incoming online chat communication, one or more destination chat participants in the plurality of chat participants in the super chat group;
transmitting one or more outgoing online chat communications to one or more destination online chat communication systems to which one or more destination chat applications operated by the one or more destination chat participants correspond, wherein each of the one or more outgoing online chat communication is generated from the incoming online chat communication.

10. The medium of claim 9, wherein at least one of the one or more outgoing online chat communications is generated with automatic natural language translation from the incoming online chat communication.

11. The medium of claim 9, wherein at least one of the one or more outgoing online chat communications is generated with automatic service adaptation from the incoming online chat communication.

12. The medium of claim 9, wherein the plurality of online chat communication systems comprises one or more of: Slack, WhatsApp, Line, WeChat, Skype, Facebook, Snapchat, Telegram, Viber, Kik, Signal, Microsoft Teams, Stride, TeamSpeak, Samepage, or Mumble.

13. The medium of claim 9, wherein the online chat communication comprises one or more of: texts, hyperlinks, images, audio, videos, or documents.

14. The medium of claim 9, wherein the computer instructions, when executed by one or more computing processors, cause the one or more computing processors to further perform:
storing a complete record of online chat communications in the super chat group since the super chat group is created;
allowing one or more users to access at least a portion of the complete record of online chat communications in the super chat group.

15. The medium of claim 9, wherein the super chat group includes at least on chat participant who operates a chat application corresponding to a chat bridging system.

16. The medium of claim 9, wherein the computer instructions, when executed by one or more computing processors, cause the one or more computing processors to further perform:
automatically determining presences of one or more communication participants based at least in part on collected sensory data from one or more of: human operated user devices, non-human internet-of-things (IoT) devices, or sensors;
enabling synchronous communication between at least two communication participants based on the automatically determined presences of the one or more communication participants.

17. An apparatus, comprising:
one or more computing processors;
a non-transitory computer readable medium that stores computer instructions which, when executed by the one or more computing processors, cause the one or more computing processors to perform:
creating a super chat group comprising a plurality of chat participants from a plurality of online chat communication systems, wherein each chat participant in the plurality of chat participants uses a respective chat application in a plurality of chat applications, wherein each chat application in the plurality of chat applications corresponds to a respective online chat communication system in the plurality of online chat communication systems;
receiving, from an origination online chat communication system in the plurality of online chat communication systems, an incoming online chat communication from an origination chat application operated by an origination chat participant in the plurality of chat participants in the super chat group;
identifying, based at least in part on destination chat participant information received with the incoming online chat communication, one or more destination chat participants in the plurality of chat participants in the super chat group;
transmitting one or more outgoing online chat communications to one or more destination online chat communication systems to which one or more destination chat applications operated by the one or more destination chat participants correspond, wherein each of the one or more outgoing online chat communication is generated from the incoming online chat communication.

18. The apparatus of claim 17, wherein at least one of the one or more outgoing online chat communications is generated with automatic natural language translation from the incoming online chat communication.

19. The apparatus of claim 17, wherein at least one of the one or more outgoing online chat communications is generated with automatic service adaptation from the incoming online chat communication.

20. The apparatus of claim 17, wherein the plurality of online chat communication systems comprises one or more of: Slack, WhatsApp, Line, WeChat, Skype, Facebook, Snapchat, Telegram, Viber, Kik, Signal, Microsoft Teams, Stride, TeamSpeak, Samepage, or Mumble.

21. The apparatus of claim 17, wherein the computer instructions, when executed by one or more computing processors, cause the one or more computing processors to further perform:
storing a complete record of online chat communications in the super chat group since the super chat group is created;
allowing one or more users to access at least a portion of the complete record of online chat communications in the super chat group.

22. The apparatus of claim 17, wherein the computer instructions, when executed by one or more computing processors, cause the one or more computing processors to further perform:
automatically determining presences of one or more communication participants based at least in part on collected sensory data from one or more of: human operated user devices, non-human internet-of-things (IoT) devices, or sensors;
enabling synchronous communication between at least two communication participants based on the automatically determined presences of the one or more communication participants.
